(19) United States
(12) Patent Application Publication
(10) Pub. No.: US 2010/0323202 A1
(43) Pub. Date: Dec. 23, 2010

(54) USE OF CARBOXYLIC ACID HYDRAZIDE FOR DE-BONDING POLYURETHANE ADHESIVES

(75) Inventors: Urs BURCKHARDT, Zurich (CH); Andreas Kramer, Zurich (CH)

Correspondence Address: BUCHANAN, INGERSOLL & ROONEY PC, POST OFFICE BOX 1404, ALEXANDRIA, VA, 22313-1404, US

(73) Assignee: Sika Technology AG, Baar (CH)

(21) Appl. No.: 12/819,731

(22) Filed: Jun. 21, 2010

(30) Foreign Application Priority Data
Jun. 19, 2009 (EP) 09163248.9

(51) Int. Cl. B32B 7/12; C08K 5/43; B32B 27/40; B29C 73/10

(52) U.S. Cl. 428/423.1; 524/169; 156/98

(57) ABSTRACT

This disclosure relates to the use of carboxylic acid hydrazide for de-bonding (e.g., detaching) polyurethane adhesives. The carboxylic acid hydrazide is present in the polyurethane adhesive as a solid in free form and is thus not incorporated in the polymer. When the adhesive is heated to a temperature of at least 80° C., the polymer is thermally degraded. With such an adhesive, components that are bonded in such a way can be detached in a simple method, by which the repair, the use or the recycling of the components is more easily possible.

### RELATED APPLICATIONS

This application claims priority under 35 U.S.C. §119 to European Patent Application No. 09163248.9 filed in Europe on Jun. 19, 2009, the entire content of which is hereby incorporated by reference in its entirety.

### FIELD

The disclosure relates to the field of polyurethane adhesives.

### BACKGROUND INFORMATION

For quite some time, the deliberate detachment of adhesive compounds, the so-called de-bonding, has posed a special challenge in adhesive technology. Accordingly, numerous approaches have been described for quick de-bonding of adhesive compounds. For example, when repairing, using or recycling glued components, the possibility of quickly de-bonding the adhesive compound can be a concern. In this case, there is an interest in the de-bonding of elastic adhesive compounds that can, for example, consist of polyurethane adhesives.

In the prior art, there are different approaches for de-bonding polyurethane adhesives. On the one hand, these are adhesive compositions containing a material that expands in heat and that can be detached by the action of heat that weakens or destroys the adhesive bond by its great expansion pressure. As heat-expanding material, for example, inorganic substances such as expanding graphite and vermiculite or organic hollow fibers and microcapsules are used, or—as described in WO 2005/028583 A1—a heat-labile hydrazide in the form of a sulfohydrazide or sulfonyl hydrazide, which breaks down into gaseous components during heating and thus also weakens or destroys the adhesive bond by expansion pressure.

In addition, attempts are known to thermally degrade the cured polyurethane polymer, for example by the incorporation of functional groups with easily cleavable bonds such as disulfide groups, oxime-urethane groups, or aryl-keto groups, or by the introduction of complexed or microencapsulated amines, of a solid dicarboxylic acid or a solid dialcohol, or by the introduction of finely dispersed small particles, for example iron alloys or ferrites, with special magnetic or electrical properties that introduce energy into the adhesive bond in the form of alternating electromagnetic fields and thus strongly heat the latter locally, which by itself—and in particular in connection with cleavage reagents, propellants or easily cleavable bonds that are present in polymer—leads to quick de-bonding.

One thing that the methods for thermal de-bonding described in the prior art have in common is that, when used in polyurethanes, for example in single-component moisture-hardening polyurethane adhesives, the methods can make implementation in a commercial product difficult or impossible. Thus, the compatibility of many of the above-mentioned additives such as amines, alcohols or sulfohydrazides with polyurethane polymers that have isocyanate groups is inadequate; (e.g., they trigger premature cross-linking reactions with the isocyanate groups, which results in a great shortening of the shelf life of the adhesive). In addition, some additives, for example the expanding materials can result in a weakening of the polyurethane polymer in the cured state, such that the mechanical strength and permanence of the adhesive during its time of use can be reduced. The same also applies for systems with incorporated weak points in the form of easily cleavable bonds. The de-bonding speed and temperature for the described systems can lie in an unsuitable range, so that heating has to take place for either too long a time or too strongly, such that an adequate weakening of the adhesive that is used for easy de-bonding is set, or, conversely, this weakening is started at too low a temperature and the adhesive thus is already damaged during its time of use and completely loses its function in the extreme case.

### SUMMARY

Methods are disclosed for de-bonding an adhesive compound, comprising: heating a cured polyurethane adhesive that contains a carboxylic acid hydrazide; and de-bonding the cured polyurethane adhesive using a de-bonding temperature of at least 80° C.

Curing compositions are also disclosed, comprising: α) at least one polyisocyanate P; and β) at least one carboxylic acid hydrazide, wherein a ratio (n_{HY}−n_{AK})/n_{NCO} has a value of 0.2 to 3, whereby n_{HY} stands for a number of hydrazide groups that are present in the composition; n_{AK} stands for a number of aldehyde and keto groups that are present and can be released into the composition; and n_{NCO} stands for a number of isocyanate groups that are present in the composition.

Cured compositions are also disclosed that contain at least one carboxylic acid hydrazide, which is obtained by curing of a curing composition that contains: α) at least one polyisocyanate P; and β) at least one carboxylic acid hydrazide, wherein a ratio (n_{HY}−n_{AK})/n_{NCO} has a value of 0.2 to 3, whereby n_{HY} stands for a number of hydrazide groups that are present in the composition, n_{AK} stands for a number of aldehyde and keto groups that are present and can be released into the composition; and n_{NCO} stands for a number of isocyanate groups that are present in the composition. at a temperature of below 80° C.

Composites are also disclosed comprising: a substrate S1; substrate S2; and a cured composition that is located between substrate S1 and substrate S2 for bonding substrate S1 and substrate S2 to one another, the cured composition containing: α) at least one polyisocyanate P; and β) at least one carboxylic acid hydrazide, wherein a ratio (n_{HY}−n_{AK})/n_{NCO} has a value of 0.2 to 3, whereby n_{HY} stands for a number of hydrazide groups that are present in the composition; n_{AK} stands for a number of aldehyde and keto groups that are present and can be released into the composition; and N_{NCO} stands for a number of isocyanate groups that are present in the composition. at a temperature of below 80° C.

Methods are also disclosed comprising: a) heating a cured polyurethane adhesive of a composite, having a substrate S1, a substrate S2, and a cured polyurethane adhesive that is located between substrate S1 and substrate S2 and that contains at least one carboxylic acid hydrazide, to a temperature of at least 80° C., with de-bonding of an adhesive compound as a result of heat-initiated thermal degradation of the cured polyurethane adhesive; b) emoving the substrate S2 from the composite; c) removing residues of the thermally degraded cured polyurethane adhesive that remain on the substrate S1; d) applying a repair adhesive to at least one of substrate S1 or S2 subsequent to step c) or d); and e) bonding of the repair adhesive to at least one of the substrate S1 or substrate S2′.

### BRIEF DESCRIPTION OF THE DRAWINGS

Exemplary embodiments of the disclosure that are based on the drawings will be explained in more detail. The same elements are provided with the same reference numbers in the various figures. Movements or actions are depicted with arrows.

FIGS. 1 to 8 show cross-sections through stages of an exemplary repair method that vary over time.

The drawings are schematic. Only the elements that are essential for the intuitive understanding of the disclosure are shown.

### DETAILED DESCRIPTION

Systems are disclosed for the simple de-bonding of polyurethane adhesives in a suitable temperature range, and for use in single-component moisture-hardening polyurethane adhesives.

Surprisingly enough, this object can be achieved with the use of a carboxylic acid hydrazide as disclosed herein. For example, at room temperature, carboxylic acid hydrazides are solid, crystalline substances with a low solubility in polyurethane adhesive. Surprisingly enough, it is possible to use them as component parts of a curing polyurethane composition in the production of an adhesive compound, without them being incorporated into polyurethane polymer during the curing of the composition, provided that the curing is carried out at a sufficiently low temperature. Surprisingly enough, carboxylic acid hydrazides that contain polyurethane adhesives can degrade thermally in a suitable temperature range and can thus become unstuck, and this takes place at use temperatures that are suitable for practical use of such adhesives, for example when using exemplary carboxylic acid hydrazides. With preferred polycarboxylic acid hydrazides, single-component, moisture-hardening polyurethane adhesives with good shelf life can also be produced.

In an exemplary method, a carboxylic acid hydrazide is used for de-bonding an adhesive compound that comprises a cured polyurethane adhesive that contains the carboxylic acid hydrazide.

In this document, the term “carboxylic acid hydrazide” refers to the condensation product that includes (e.g., consists of) a carboxylic acid and hydrazine.

In this document, a solid compound of at least two substrates that includes (e.g., consists of) the same or a different material with an adhesive is referred to as an “adhesive compound.”

In this document, the specific weakening of the adhesive relative to its strength is referred to as “de-bonding” of an adhesive compound. As a result, the mechanical separation of the substrates is made possible with relatively little effort, (e.g., the adhesive compound can be readily dissolved). The separation can be carried out either in an adhesive manner between an adhesive and a substrate surface or in a cohesive manner in the adhesive.

In this document, a polyurethane adhesive in which the chemical cross-linking reaction is essentially terminated and that is thus essentially free of isocyanate groups is referred to as “cured.”

In this document, the term “polyurethane adhesive” refers to an adhesive that in the cured state contains a polyurethane polymer.

The term “polyurethane polymer” encompasses all polymers that are produced according to the so-called diisocyanate-polyaddition method. In addition to urethane or thiourethane groups, such polyurethane polymers can, for example, also have urea groups.

In this document, on the one hand, the term “polymer” encompasses a population of macromolecules that are chemically uniform but are different relative to the degree of polymerization, molecular weight and chain length, and the population was produced by a polyreaction (polymerization, polyaddition, polycondensation). On the other hand, the term also encompasses derivatives of such a population of macromolecules from polyreactions, (e.g., compounds that were obtained by reactions, such as, for example, additions or substitutions, of functional groups on specific macromolecules) and that can be chemically uniform or chemically inconsistent. In addition, the term also encompasses so-called prepolymers, (e.g., reactive oligomeric prepolymers whose functional groups are involved in the creation of macromolecules).

In this document, the term “polyisocyanate” encompasses compounds with two or more isocyanate groups, regardless of whether these are polymers with a relatively high molecular weight that have monomeric diisocyanates, oligomeric polyisocyanates or isocyanate groups.

An amine or an isocyanate whose amino or isocyanate groups in each case are bonded exclusively to aliphatic, cycloaliphatic or aryl-aliphatic radicals is referred to as “aliphatic”; accordingly, these groups are referred to as aliphatic amino or isocyanate groups.

An amine or an isocyanate whose amino or isocyanate groups in each case are bonded to an aromatic radical is referred to as “aromatic”; accordingly, these groups are referred to as aromatic amino or isocyanate groups.

In this document, a temperature in the range of 20° C. to 25° C. is referred to as “room temperature.”

In this document, the fat-labeled references such as HY, P, PI, PUP, K1, K2, S1, S2 or the like are used only for better reading comprehension and identification.

Carboxylic acid hydrazides can be less toxic crystalline substances with a relatively low solubility that are solid at room temperature and that can be obtained by, for example, condensation of carboxylic acids with hydrazine or hydrazine hydrate.

In a first exemplary embodiment, suitable carboxylic acid hydrazides are hydrazides of monocarboxylic acids, on the one hand, of aliphatic and aryl-aliphatic acids, such as lauric acid, palmitic acid, stearic acid, cyanoacetic acid, 2,4-dichlorophenoxyacetic acid, 4-nitrophenoxyacetic acid, and 1-naphthylacetic acid; and, on the other hand, of aromatic and heteroaromatic monocarboxylic acids, such as benzoic acid, 2-, 3- and 4-chlorobenzoic acid, 2-, 3- and 4-bromobenzoic acid, 2- and 4-toluic acid, 2-, 3- and 4-nitrobenzoic acid, salicylic acid, 4-tert-butyl-benzoic acid, 4-methoxybenzoic acid, 4-ethoxybenzoic acid, 4-trifluorobenzoic acid, 4-dimethylaminobenzoic acid, the isomeric dichlorobenzoic acids, dimethoxybenzoic acids, and trimethoxybenzoic acids, terephthalic acid monomethyl ester, 1-naphthylcarboxylic acid, 3-hydroxy-2-naphthylcarboxylic acid, 4-biphenylcarboxylic acid, nicotinic acid, isonicotinic acid, 2-thiophenecarboxylic acid, 4-imidazole carboxylic acid and 3-pyrazole carboxylic acid.

In another exemplary embodiment, suitable carboxylic acid hydrazides are hydrazides of polycarboxylic acids, such as monohydrazides and dihydrazides of dicarboxylic acids such as glutaric acid, pimelic acid and terephthalic acid; mono-, di- and trihydrazides of tricarboxylic acids such as benzenetricarboxylic acid; as well as preferably the polycarboxylic acid hydrazides HY that are described below.

The carboxylic acid hydrazide can be in fine-particle form. It can have a mean particle diameter of, for example, less than 120 μm, preferably 0.5 to 100 μm, and especially preferably 0.5 to 50 μm.

As a carboxylic acid hydrazide, a carboxylic acid hydrazide with a melting point in the range of, for example, 160° C. to 260° C., in particular 175° C. to 240° C., is preferred. These are, for example, the hydrazides of 4-nitrophenoxyacetic acid, 1-naphthylacetic acid, nicotinic acid, isonicotinic acid, 1-naphthylcarboxylic acid, 4-biphenylcarboxylic acid, 3-hydroxy-2-naphthylcarboxylic acid, benzothiophene-2-carboxylic acid, imidazole-4-carboxylic acid, 4-nitrobenzoic acid, 4-chlorobenzoic acid, the isomeric dichlorobenzoic acids as well as the polycarboxylic acid hydrazides HY that are described below.

A polycarboxylic acid hydrazide HY is, for example, especially preferred as a carboxylic acid hydrazide. The polycarboxylic acid hydrazide HY has a melting point in the range of, for example, 160° C. to 260° C., in particular 175° C. to 240° C., and has in particular the formula (I)

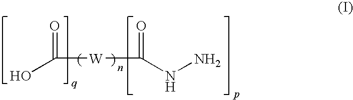

whereby

W stands for a (p+q)-value organic radical;

p stands for 1 or 2 or 3, and

o stands for 0 or 1 or 2,

provided that (p+q) stands for 2 or 3 or 4; and

n stands for 0 or 1.

Polycarboxylic acid hydrazides HY of formula (I), in which n stands for 0, are derived from oxalic acid. In this case, the sum (p+q) stands for 2.

Polycarboxylic acid hydrazides HY can be obtained by, for example, the condensation of suitable polycarboxylic acids with hydrazine or hydrazine hydrate, whereby as polycarboxylic acids, for example, oxalic acid, succinic acid, adipic acid, suberic acid, azelaic acid, sebacic acid, dodecanedioic acid and isophthalic acid are suitable.

The polycarboxylic acid hydrazide HY is, for example, a dicarboxylic acid hydrazide, in particular a dicarboxylic acid hydrazide.

Oxalic acid dihydrazide, succinic acid dihydrazide, adipic acid dihydrazide, suberic acid dihydrazide, azelaic acid dihydrazide, sebacic acid dihydrazide, dodecanedioic acid dihydrazide and isophthalic acid dihydrazide are especially suitable as polycarboxylic acid hydrazide HY.

The polycarboxylic acid hydrazide HY is especially preferably selected from the group that consists of oxalic acid dihydrazide, adipic acid dihydrazide, azelaic acid dihydrazide, sebacic acid dihydrazide, and isophthalic acid dihydrazide.

Most preferred as polycarboxylic acid hydrazide HY are oxalic acid dihydrazide and adipic acid dihydrazide.

Single-component polyurethane adhesives, which are designated suitable for storage at temperatures of up to approximately 60° C., can especially also be formulated with polycarboxylic acid hydrazides HY.

In this disclosure, the carboxylic acid hydrazide is a component part of a cured polyurethane adhesive, whereby it is present therein in free form, (e.g., with chemically unaltered hydrazide groups), and thus it is not incorporated in the polyurethane polymer of the adhesive but rather is dispersed as a solid in the latter. When the adhesive is heated, the carboxylic acid hydrazide begins to react, surprisingly enough, with the polyurethane polymer. The polymer can contain urethane and/or thiourethane and/or urea groups, whereby the urethane groups are derived, for example, from the reaction of isocyanate groups with hydroxyl groups, such as the thiourethane groups from the reaction of isocyanate groups with mercapto groups, and the urea groups from the reaction of isocyanate groups with amino groups or with water. The heat-initiated reaction of the carboxylic acid hydrazide with the polyurethane polymer presumably occurs essentially via the urethane, thiourethane and/or urea groups, by the latter being attacked and opened by the highly nucleophilic hydrazide groups, whereby, for example, acyl semicarbazide groups of formula (II) as well as free hydroxyl, mercapto and/or amino groups can be produced. With the opening of the urethane, thiourethane and/or urea groups, the chain length or the molecular weight of the polyurethane polymer is reduced; the polymer is cleaved by the reaction with the carboxylic acid hydrazide in the chain. Based on the number of opened urethane, thiourethane and/or urea groups, it thus results in a more or less greatly pronounced drop in the mechanical strength of the cured polyurethane adhesive, by which the de-bonding of the adhesive compound results. The latter can then be mechanically separated with significantly less effort than before the de-bonding.

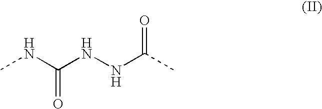

For de-bonding, the cured polyurethane adhesive that contains the carboxylic acid hydrazide is heated. The temperature to which the adhesive is heated for de-bonding the adhesive compound is also referred to below as the “de-bonding temperature.”

The de-bonding temperature is, for example, at least 80° C., preferably above 100° C., especially preferably in the range of 120° C. to 240° C., and most preferably in the range of 140° C. to 220° C.

In exemplary embodiments, it can be important that the de-bonding take place only considerably above the “use temperature”—i.e., the maximum temperature that occurs when the adhesive compound is used—so that the adhesive permanently maintains its adhesive force and it does not result unintentionally in premature de-bonding. For bonding in interior spaces, use temperatures of up to, for example, approximately 50° C. can be expected. For such applications, de-bonding temperatures in the range of 80° C. to 100° C. are suitable. For adhesive applications, however, which are used in the outer range, higher use temperatures can be expected. Adhesive compounds in automobiles, buses or train cars, for example, have use temperatures of, for example, about 80° C. For such applications, the de-bonding temperature is preferably above 100° C., in particular in the range of 120° C. to 240° C., most preferably in the range of 140° C. to 220° C. For these relatively high use or de-bonding temperatures, carboxylic acid hydrazides with a melting point in the range of, for example, 160° C. to 260° C., in particular 175° C. to 240° C., are especially suitable. These carboxylic acid hydrazides are to a large extent unreactive in the temperature range below about 100° C. in the cured polyurethane adhesive, presumably because of their low solubility in the polyurethane adhesive and their high melting point. When heating to a temperature of above 100° C., these carboxylic acid hydrazides then begin to react, however, with the polyurethane polymer, presumably in the described way; the reaction in most cases starts already clearly below the melting point of the carboxylic acid hydrazide.

Compared to monocarboxylic acid hydrazides, the polycarboxylic acid hydrazides HY can have the advantage that they have a still lower solubility in polyurethane adhesives and thus, with a similar melting point of the carboxylic acid hydrazide, in general they begin to react with the polyurethane polymer only at higher temperatures.

The amount of carboxylic acid hydrazide in the cured polyurethane adhesive can be advantageously set in such a way that the ratio between the hydrazide groups and the sum of urethane, thiourethane and urea groups is 0.2 to 3, in particular 0.5 to 2. In this case, it can be taken into consideration whether other groups are present in the adhesive that are even more reactive to hydrazide groups, such as aldehyde or keto groups that originate in particular from latent amine curing agents, such as enamines, oxazolidines, aldimines or ketimines. If this is the case, the number of hydrazide groups should be increased by the number of such additional reactive groups, since a portion of the hydrazide groups can react with these additional reactive groups during storage or at the latest when the adhesive is heated and thus is not available for the de-bonding of the adhesive compound via the cleavage of the polyurethane polymer chains.

Thus, the carboxylic acid hydrazide in the cured polyurethane adhesive can be advantageously present in such an amount that the ratio (n_{NY′}−n_{NK′})/n_{UH}, for example, 0.2 to 3, in particular 0.5 to 2,

whereby n_{HY′} stands for the number of hydrazide groups that are present in the cured polyurethane adhesive,

n_{AK′} stands for the number of aldehyde and keto groups that are present in the cured polyurethane adhesive, and

n_{UH} stands for the number of urethane, thiourethane and urea groups that are present in the cured polyurethane adhesive.

For the de-bonding of an adhesive compound, it can be advantageous when the carboxylic acid hydrazide is present in the cured polyurethane adhesive in finely dispersed form, so that during heating, it is as universally available in the adhesive as possible for the de-bonding of the adhesive compound.

A cured polyurethane adhesive that contains at least one carboxylic acid hydrazide can be obtained by, for example, the curing of a curing composition that comprises at least one polyisocyanate and at least one carboxylic acid hydrazide at a sufficiently low temperature that ensures that the carboxylic acid hydrazide does not react with the polyisocyanate to a significant extent before and during the curing of the composition. The curing temperature can be, for example, below 60° C., in particular within the room temperature range. If a carboxylic acid hydrazide with a melting point in the range of, for example, 160° C. to 260° C., in particular 175° C. to 240° C., in particular a polycarboxylic acid hydrazide HY, is used, the latter—even at a higher curing temperature up to the range of 80° C.—remains essentially unreactive compared to the polyisocyanate and thus remains to a large extent in free form in the cured polyurethane adhesive, where it is available for the de-bonding of an adhesive compound that comprises this adhesive.

In the curing composition, the carboxylic acid hydrazide is advantageously present in such an amount that the ratio (n_{HY}−n_{AK})/n_{NCO} is, for example, 0.2 to 3, in particular 0.5 to 2,

whereby n_{HY} stands for the number of hydrazide groups that are present in the composition,

n_{NK} stands for the number of aldehyde and keto groups that are present and can be released into the composition, and

n_{NCO} stands for the number of isocyanate groups that are present in the composition.

The polyisocyanate is, for example, a polyisocyanate P.

In an exemplary embodiment, the polyisocyanate P is a polyurethane polymer PUP that has an isocyanate group.

A suitable polyurethane polymer PUP is available, for example, from the reaction of at least one polyol with at least one polyisocyanate. This reaction can be carried out in that the polyol and the polyisocyanate are brought to reaction with the known methods, for example at temperatures of 50° C. to 100° C., optionally with the simultaneous use of suitable catalysts, whereby the polyisocyanate is metered in such a way that its isocyanate groups are present in stoichiometric excess relative to the hydroxyl groups of the polyol. The polyisocyanate can be metered in such a way that an NCO/OH ratio of 1.3 to 5, in particular 1.5 to 3, is maintained. The “NCO/OH ratio” is defined as the ratio of the number of the isocyanate groups that are used to the number of the hydroxyl groups that are used. After the reaction of all of the hydroxyl groups of the polyol, a content of free isocyanate groups of, for example, 0.5 to 15% by weight, especially preferably 0.5 to 5% by weight, preferably remains in the polyurethane polymer PUP.

Optionally, the polyurethane polymer PUP can be produced with simultaneous use of softeners, whereby the softeners that are used do not contain any reactive groups compared to isocyanates.

As polyols for the production of a polyurethane polymer PUP, for example, the following commercially available polyols or mixtures thereof can be used:
Polyoxyalkyene polyols, also polyether polylols or oligoetherols, are mentioned, which are polymerization products of ethylene oxide, 1,2-propylene oxide, 1,2- or 2,3-butylene oxide, oxetane, tetrahydrofuran or mixtures thereof, optionally polymerized using a starter molecule with two or more active hydrogen atoms, such as, for example, water, ammonia or compounds with several OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane-dimethanol, bisphenol A, hydrogenated bisphenol A, 1,1,1-trimethylolethane, 1,1,1-trimethylolpropane, glycerol, aniline, as well as mixtures of the above-mentioned compounds. Both polyoxyalkylene polyols that have a low degree of unsaturation (measured according to ASTM D-2849-69 and indicated in milliequivalents of unsaturation per gram of polyol (mEq/g))—produced, for example, using so-called double metal cyanide complex catalysts (DMC catalysts)—and polyoxyalkylene polyols with a higher degree of unsaturation—produced, for example, using anionic catalysts, such as NaOH, KOH, CsOH or alkali alcoholates, can be used. Polyoxyalkylene diols or polyoxyalkylene triols, such as polyoxyethylene- and polyoxypropylene di- and triols, are especially suitable.
Polyoxyalkylene diols and -triols with a degree of unsaturation of less than 0.02 mEq/g and with a molecular weight in the range of 1,000-30,000 g/mol, as well as polyoxypropylene diols and -triols with a molecular weight of 400-8,000 g/mol, are especially suitable.
So-called ethylene oxide-terminated (“EO-endcapped,” ethylene oxide-endcapped) polyoxypropylene polyols are also especially suitable. The latter are especially polyoxypropylene-polyoxyethylene polyols, which are obtained, for example, in that pure polyoxypropylene polyols, in particular polyoxypropylene diols and -triols, after the polypropoxylation reaction is concluded, are further alkoxylated with ethylene oxide and thus have primary hydroxyl groups.
Styrene-acrylonitrile- or acrylonitrile-methylmethacrylate-plugged polyether polyols.
Polyester polyols, also called oligoesterols, produced according to known methods, in particular the polycondensation of hydroxycarboxylic acids or the polycondensation of aliphatic and/or aromatic polycarboxylic acids with divalent or multivalent alcohols.

Especially suitable as polyester polyols are those that are produced from divalent to trivalent, in particular divalent, alcohols, such as, for example, ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimer diol), hydroxypivalic acid neopentyl glycol ester, glycerol, 1,1,1-trimethylolpropane or mixtures of the above-mentioned alcohols, with organic di- or tricarboxylic acids, such as dicarboxylic acids, or their anhydrides or esters, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic acid anhydride, isophthalic acid, terephthalic acid, dimethyl terephthalate, hexahydrophthalic acid, trimellitic acid and trimellitic acid anhydride or mixtures of the above-mentioned acids, as well as polyester polyols that consist of lactones, such as, for example, ε-caprolactone and starters such as the above-mentioned divalent or trivalent alcohols.

Especially suitable polyester polyols are polyester diols.
Polycarbonate polyols, as they are available by reaction of, for example, the above-mentioned alcohols—used for the creation of polyester polyols—with dialkylcarbonates, diaryl carbonates or phosgene.
At least two hydroxyl-group-carrying block copolymers that have at least two different blocks with polyether, polyester and/or polycarbonate structures of the above-described type, in particular polyether-polyester polyols.
Polyacrylate- and polymethacrylate polyols.
Polyhydroxy-functional fats and oils, for example natural fats and oils, in particular castor oil; or polyols—so-called oleochemical polyols—obtained by chemical alteration of natural fats and oils, for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical cross-linking, for example by re-esterification or dimerization, of the thus obtained degradation products or derivatives thereof. Suitable degradation products of natural fats and oils are in particular fatty acids and fatty alcohols as well as fatty acid esters, in particular the methyl ester (FAME) that can be derivatized, for example, by hydroformylation and hydrogenation to form hydroxy fatty acid esters.
Polyhydrocarbon polyols, also called oligohydrocarbonols, such as, for example, polyhydroxy-functional polyolefins, polyisobutylenes, polyisoprenes; polyhydroxy-functional ethylene-propylene-, ethylene-butylene- or ethylene-propylene-diene copolymers, as they are produced by, for example, the company Kraton Polymers; polyhydroxy-functional polymers of dienes, in particular of 1,3-butadiene, which can be produced in particular also from anionic polymerization; polyhydroxy-functional copolymers that consist of dienes, such as 1,3-butadiene or diene mixtures and vinyl monomers such as styrene, acrylonitrile, vinyl chloride, vinyl acetate, vinyl alcohol, isobutylene and isoprene, for example polyhydroxy-functional acrylonitrile/butadiene copolymers, as they can be produced from, for example, epoxides or amino alcohols and carboxyl-terminated acrylonitrile/butadiene copolymers (for example commercially available under the names Hypro® (previously)Hycar®) CTBN and CTBNX and ETBN of Nanoresins AG, Germany, or Emerald Performance Materials LLC); as well as hydrogenated polyhydroxy-functional polymers or copolymers of dienes.

These above-mentioned polyols have, for example, a mean molecular weight of 250-30,000 g/mol, such as 400-20,000 g/mol, and preferably a mean OH-functionality in the range of 1.6 to 3.

As polyols, polyether-, polyester-, polycarbonate- and polyacrylate polyols, preferably diols and triols, are preferred. Polyether polyols, polyoxypropylene- and polyoxypropylene-polyoxyethylene polyols, as well as liquid polyester polyols and polyether-polyester polyols, are especially preferred.

In addition to these above-mentioned polyols, small amounts of low-molecular, divalent or multivalent alcohols, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols, such as xylitol, sorbitol, or mannitol, sugars such as saccharose, other alcohols of higher valence, low-molecular alkoxylating products of the above-mentioned divalent and multivalent alcohols, as well as mixtures of the above-mentioned alcohols can be used simultaneously in the production of the polyurethane polymer PUP. Also, small amounts of polyols with a mean OH functionality of more than 3, for example sugar polyols, can be used simultaneously.

Aromatic or aliphatic polyisocyanates, such as diisocyanates, can be used as a polyisocyanate for the production of a polyurethane polymer PUP that has isocyanate groups.

As aromatic polyisocyanates, the following are, for example, suitable: monomeric di- or triisocyanates, such as 2,4- and 2,6-toluylene diisocyanate and any mixtures of these isomers (TDI), 4,4′-, 2,4′- and 2,2′-diphenylmethane diisocyanate and any mixtures of these isomers (MDI), mixtures that consist of MDI and MDI homologs (polymeric MDI or PMDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), 1,3,5-tris-(isocyanatomethyl)-benzene, tris-(4-isocyanatophenyl)-methane, tris-(4-isocyanatophenyl)-thiophosphate, oligomers and polymers of the above-mentioned isocyanates, as well as any mixtures of the above-mentioned isocyanates. MDI and TDI are preferred.

As aliphatic polyisocyanates, the following are, for example, suitable: monomeric di- or triisocyanates such as 1,4-tetramethylene diisocyanate, 2-methylpentamethylene-1,5-diisocyanate, 1,6-hexamethylene diisocyanate (HDI), 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and -1,4-diisocyanate, 1-methyl-2,4- and -2,6-diisocyanato-cyclohexane, and any mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis-(isocyanatomethyl-cyclohexane, m- and p-xylylene diisocyanate (m- and p-XDI), m- and p-tetramethyl-1,3- and -1,4-xylylene diisocyanate (m- and p-TMXDI), bis-(1-isocyanato-1-methylethyl)-naphthalene, dimeric and trimeric fatty acid isocyanates, such as 3,6-bis-(9-isocyanatononyl)-4,5-di-(1-heptenyl)-cyclohexene dimeryl diisocyanate), α,α,α′,α′,α″,α″-hexamethyl-1,3,5-mesitylene triisocyanate, oligomers and polymers of the above-mentioned isocyanates, as well as any mixtures of the above-mentioned isocyanates. HDI and IPDI are preferred.

Polyurethane polymers PUP with aromatic isocyanate groups are, for example, preferred.

In another exemplary embodiment, the polyisocyanate P is a polyisocyanate PI in the form of a monomeric di- or triisocyanate or an oligomer of a monomeric diisocyanate or a derivative of a monomeric diisocyanate, whereby as a monomeric di- or triisocyanate, in particular the above-mentioned aromatic and aliphatic di- and triisocyanates are suitable.

As polyisocyanate PI, the following are especially suitable: oligomers or derivatives of monomeric diisocyanates, in particular HDI, IPDI, TDI and MDI. Commercially available types are in particular HDI biurets, for example as Desmodur® N 100 and N 3200 (from Bayer), Tolonate® HDB and HDB-LV (from Rhodia) and Duranate® 24A-100 (from Asahi Kasei); HDI isocyanurates, for example as Desmodur® N 3300, N 3600 and N 3790 BA (all from Bayer), Tolonate® HDT, HDT-LV, and HDT-LV2 (from Rhodia), Duranate® TPA-100 and THA-100 (from Asahi Kasei) and Coronate® HX (from Nippon Polyurethanes); HDI uretdiones, for example as Desmodur® N 3400 (from Bayer); HDI-iminooxadiazinediones, for example as Desmodur® XP 2410 (from Bayer); HDI-allophanates, for example as Desmodur® VP LS 2102 (from Bayer); IPDI isocyanurates, for example in solution as Desmodur® Z 4470 (from Bayer) or in solid form as Vestanat® T1890/100 (from Degussa); TDI oligomers, for example as Desmodur® IL (from Bayer); as well as mixed isocyanurates based on TDI/HDI, for example as Desmodur® HL (from Bayer). In addition, the following are especially suitable at room temperature: liquid forms of MDI (so-called “altered MDI”), which represent mixtures of MDI with MDI derivatives, such as, for example, MDI carbodiimides or MDI uretonimines or MDI urethanes, known, for example, under trade names such as Desmodur® CD, Desmodur® PF, ^{Desmodur}® PC (all from Bayer), as well as mixtures of MDI and MDI homologs (polymeric MDI or PMDI), available under trade names such as Desmodur® VL, Desmodur® VL50, Desmodur® VL R10, Desmodur® VL R20 and Desmodur® VKS 20F (all from Bayer), Isonate® M 309, Voranate® M 229, and Voranate® M 580 (all from Dow) or Lupranat® M 10 R (from BASF).

The above-mentioned oligomeric polyisocyanates PI in practice can represent mixtures of substances with different degrees of oligomerization and/or chemical structures. They can, for example, have a mean NCO functionality of 2.1 to 4.0 and contain isocyanurate, iminooxadiazinedione, uretdione, urethane, biuret, allophanate, carbodiimide, uretonimine, or oxadiazinetrione groups. These oligomers can have a low content of monomeric diisocyanates.

As polyisocyanate PI, forms of MDI that are liquid at room temperature, as well as the oligomers of HDI, IPDI and TDI, in particular the isocyanurates and the biurets, are preferred.

In another embodiment, the polyisocyanate P is a mixture that consists of at least one polyurethane polymer PUP and at least one polyisocyanate PI, as they were described previously.

The curing composition can be present as a single-component or as a two-component composition.

In an exemplary embodiment, the curing composition is a single-component composition.

In this document, a curing composition in which all component parts of the composition are stored mixed in the same drum and that has a long shelf life over an extended period at room temperature—thus is not altered or only slightly altered in its application or use properties by storage—and that cures by the action of moisture according to the application, is referred to as “single-component.”

In a single-component composition, the carboxylic acid hydrazide can be present in the form of a polycarboxylic acid hydrazide HY, as it was previously described, and can be selected, for example, in particular from the group that consists of oxalic acid dihydrazide, adipic acid dihydrazide, azelaic acid dihydrazide, sebacic acid dihydrazide, and isophthalic acid dihydrazide.

Polycarboxylic acid hydrazides HY are especially suitable as components of a single-component composition, since they do not react with isocyanate groups at temperatures of up to approximately 60° C., and such single-component compositions therefore have a good shelf life. Carboxylic acid hydrazides with a lower melting point can already react with isocyanate groups at lower temperatures, which can result in a strong increase in viscosity and ultimately to gelling during storage of a corresponding single-component composition. Also, monocarboxylic acid hydrazides with a melting point in the range of 160° C. to 260° C. can react with isocyanate groups even at lower temperatures during storage. This is presumably due to the fact that the solubility of monocarboxylic acid hydrazides in the composition is generally higher than that of polycarboxylic acid hydrazides with a comparable melting point, and thus despite their high melting points even at lower temperatures, the monocarboxylic acid hydrazides are available as reactants for isocyanate groups.

In a single-component composition, the polyisocyanate P is, for example, present as a polyurethane polymer PUP that has isocyanate groups.

In the single-component composition, the polyisocyanate P can be present in an amount of 5 to 95% by weight, preferably in an amount of 10 to 90% by weight, relative to the entire composition. In filled compositions, (e.g., compositions that contain a filler) the polyisocyanate P can be present in an exemplary amount of 5 to 60% by weight, in particular 10 to 50% by weight, relative to the entire composition.

The single-component composition optionally contains so-called latent curing agents in the form of blocked amines that can be activated hydrolytically, such as substances with oxazolidino or aldimino groups. Especially suitable are condensation products of primary aliphatic polyamines, as they are usually used as component parts of two-component polyurethane compositions, with suitable aldehydes. Especially suitable are polyaldimines with aldimino groups, which do not carry any hydrogen atoms on the C atom that stands for the carbonyl group in the α-position and therefore cannot tautomerize to form enamino groups. Such aldimino groups represent especially well protected (“blocked”) primary amino groups that show only extremely low or no reactivity under moisture-free conditions with isocyanate groups and therefore in general are especially well suited for storage together with free isocyanate groups. If such latent curing agents come into contact with moisture in the presence of isocyanate groups, they react under hydrolysis and release of aldehydes with isocyanate groups to form urea groups. Latent curing agents that, as they hydrolyze, release low-odor or odor-free, low-volatile aldehydes, such as, for example, 2,2-dimethyl-3-lauroyloxy-propanal, are also especially suitable. Starting from such latent curing agents, single-component polyurethane adhesives are available that cure quickly, do not form bonds and have little or no odor, which can be a great advantage for many applications, such as in interior spaces.

The single-component composition optionally contains additional component parts, in particular adjuvants and additives that are usually used in polyurethane compositions, for example the following:
Softeners, such as carboxylic acid esters such as phthalates, in particular dioctyl phthalate, diisononyl phthalate, or diisodecyl phthalate, adipates, in particular dioctyl adipate, azelates and sebacates, organic phosphoric and sulfonic acid esters or polybutenes;
Non-reactive thermoplastic polymers, such as, for example, homo- or copolymers of unsaturated monomers, in particular from the group that comprises ethylene, propylene, butylene, isobutylene, isoprene, vinyl acetate and alkyl(meth)acrylates, in particular polyethylene (PE), polypropylene (PP), polyisobutylene, ethylene vinyl acetate copolymers (EVA), and atactic poly-α-olefins (APAO);
Solvents,
Inorganic and organic fillers, in particular ground or precipitated calcium carbonates, which optionally are coated with fatty acids, in particular stearates, barite (BaSO₄, also called barium sulfate), quartz flour, calcinated kaolins, aluminum oxides, aluminum hydroxides, silicic acids, in particular highly dispersed silicic acids from pyrolysis processes, carbon black, in particular industrially produced carbon black (referred to as “carbon black” below), PVC powder, or hollow spheres;
Fibers, for example made of polyethylene;
Pigments, for example titanium dioxide or iron oxides;
Catalysts, in particular organotin compounds, such as dibutyltin diacetate, dibutyltin dilaurate, dibutyltin dichloride, dibutyltin diacetylacetonate and dioctyltin dilaurate, bismuth compounds such as bismuth trioctoate and bismuth-tris(neodecanoate); compounds that contain tert-amino groups, in particular 2,2′-dimorpholino diethyl ether and 1,4-diazabicyclo[2,2,2]octane; and acids, in particular benzoic acid, salicylic acid, or 2-nitrobenzoic acid;
Rheology modifiers, such as in particular thickeners or thixotroping agents, for example urea compounds, polyamide waxes, bentonites or pyrogenic silicic acids;
Drying agents, such as, for example, molecular sieves, calcium oxide, highly reactive isocyanates such as p-tosylisocyanate, orthoformic acid ester, alkoxysilanes such as tetraethoxysilane, organoalkoxysilanes such as vinyl trimethoxysilane, and organoalkoxysilanes, which have a functional group in α-position to the silane group,
Adhesion promoters, in particular organoalkoxysilanes (“silanes”), such as, for example, epoxysilanes, vinyl silanes, (meth)acryl silanes, isocyanatosilanes, carbamatosilanes, alkylsilanes, S-(alkylcarbonyl)-mercaptosilanes and aldiminosilanes, as well as oligomeric forms of these silanes;
Stabilizers to protect against heat, light and UV radiation;
Flame-retardant substances;
Surfactants, such as in particular wetting agents, flow enhancers, ventilating agents, or foam inhibitors;
Pesticides, such as, for example, algicides, fungicides or substances inhibiting fungal growth.

The single-component composition optionally in addition can contain a material that increases the conductivity of heat of the composition and/or, because of its piezoelectric, ferromagnetic or superparamagnetic properties, it allows the composition to heat by applying alternating magnetic and/or electrical fields, in particular microwaves, induction or NIR. This allows the composition, which in general has limited heat conductivity, to heat more quickly and thus allows an adhesive compound that comprises the cured composition or the cured polyurethane adhesive to de-bond more quickly. As such material, the following are suitable: in particular graphite, conductive carbon black and metal powder; piezoelectric agents such as quartz, tourmaline, barium titanate, lithium sulfate, potassium(sodium) tartrate, ethylene diamine tartrate and lead-zirconium-titanate; ferromagnetic or superparamagnetic agents such as the metals aluminum, cobalt, iron, nickel and their alloys, metal oxides such as n-maghemite (γ-Fe₂O₃), n-magnetite (Fe₃O₄), as well as ferrites of general formula MFe₂O₄, whereby M stands for divalent metals from the group copper, zinc, cobalt, nickel, magnesium, calcium or cadmium. This material is preferably present in fine-particle form, whereby the mean particle diameter is below 120 μm, and in particular below 50 μm. For the use of the superparamagnetic effect, the mean particle diameter is, for example, below 50 nm, and in particular below 30 nm.

When using such additional component parts, it is advantageous to ensure that the latter do not unduly increase the solubility of the carboxylic acid hydrazide, in particular a polycarboxylic acid hydrazide HY, in the composition.

In addition, it can be advantageous, when using such additional component parts, to ensure that these parts do not greatly impair the shelf life of the single-component composition. That is, during storage, these component parts should not trigger to a significant extent the reactions that lead to cross-linking. For example, all of these component parts of exemplary compositions should contain no water or at most only traces of water. It may be advisable to dry certain component parts chemically or physically before mixing them into the composition.

The single-component composition can, for example, contain at least one catalyst.

The single-component composition is produced and stored under moisture-free conditions. It has a long shelf life (e.g., it can be stored under moisture-free conditions in a suitable packaging or arrangement, such as, for example, a drum, a bucket, a bag, a cartridge or a bottle over a period of, for example, several months, without its being altered in its application properties or in its properties after curing to an extent that is relevant for its use). The shelf life can be determined by measuring viscosity or extrusion force.

The moisture that is used for curing can be derived either from the air (atmospheric humidity), or else the composition can be brought into contact with a water-containing component, for example by smearing, for example with a smoothing agent, or by spraying, or it can be added to the composition with the application of a water-containing component, for example in the form of an aqueous paste, which is mixed in, for example, with a static mixer.

In another exemplary embodiment, the curing composition is a two-component composition.

In this document, a curing composition in which the component parts of the composition are present in two components that are separate from one another and that in each case can be stored in separate barrels with a long shelf life is referred to as “two-component.” Not until just shortly before or during the application of the composition are the two components mixed together, whereupon the mixed composition is cured optionally with the participation of moisture.

The two-component composition consists of a first component K1 and a second component K2, whereby the first component K1 contains the polyisocyanate P, and the second component K2 contains a polyol and/or a polythiol and/or a polyamine. The carboxylic acid hydrazide can be contained in the component K1 and/or in the component K2. The carboxylic acid hydrazide can be a component part of the component K2.

In a two-component composition, the carboxylic acid hydrazide can have a melting point in the range of 160° C. to 260° C.

If the carboxylic acid hydrazide is present in the form of a monocarboxylic acid hydrazide, the latter is in particular suitable as a component part of the component K2.

Especially preferably, the carboxylic acid hydrazide can be present in the form of a polycarboxylic acid hydrazide HY, as it was previously described, and it is selected in particular from the group that consists of oxalic acid dihydrazide, adipic acid dihydrazide, azelaic acid dihydrazide, sebacic acid dihydrazide, and isophthalic acid dihydrazide.

In the two-component composition, the polyisocyanate P can be present preferably as polyisocyanate PI, as it was previously described.

The same polyols that were already previously mentioned for the production of a polyurethane polymer PUP, as well as the low-molecular divalent or multivalent alcohols already previously mentioned for simultaneous use in the production of a polyurethane polymer PUP, are suitable as polyols in the component K2.

Liquid mercapto-terminated polymers that are known, for example, under the trade name Thiokol®, in particular the types such as LP-3, LP-33, LP-980, LP-23, LP-55, LP-56, LP-12, LP-31, LP-32 and LP-2 (Morton Thiokol; for example available from SPI Supplies, USA, or from Toray Fine Chemicals, Japan), as well as polyesters from thiocarboxylic acids, in particular pentaerythritol tetramercaptoacetate, trimethylol propanetrimercaptoacetate, glycol dimercaptoacetate, pentaerythritol tetra-(3-mercaptopropionate), trimethylolpropanetri-(3-mercaptopropionate) and glycol di-(3-mercaptopropionate), are suitable as polythiols in the component K2.

As polyamines in the component K2, the amines that are used as curing agents for isocyanates are suitable, such as:
Primary aliphatic polyamines, such as, for example, 1,3-pentanediamine (DAMP), 1,5-diamino-2-methylpentane (MPMD), 1,6-hexamethylene diamine, 2,2,4- and 2,4,4-trimethylhexamethylene diamine (TMD), 1-amino-3-aminomethyl-3,5,5-trimethylcyclohexane (=isophorone diamine or IPDA), 1,3-xylylene diamine, 1,3-bis-(aminomethyl)cyclohexane, bis-(4-aminocyclohexyl)-methane, bis-(4-amino-3-methylcyclohexyl)-methane, 3(4),8(9)-bis-(aminomethyl)-tricyclo[5,2,1,0^{2.6}]decane, 1,2-, 1,3- and 1,4-diaminocyclohexane, 1,4-diamino-2,2,6-trimethylcyclohexane (TMCDA) and 4-aminomethyl-1,8-octanediamine;
Ether-group-containing aliphatic diamines, such as, for example, 3,6-dioxaoctane-1,8-diamine, 4,7-dioxadecane-1,10-diamine and polyoxyalkylene di- and triamines, which typically represent products from the amination of polyoxyalkylene diols, in particular the types D-230, D-400, D-2000, T-403, and T-5000 of Huntsman that are available under the trade name Jeffamine® and compounds from BASF or Nitroil that are analogous thereto;
Secondary aliphatic polyamines, such as, for example, N,N′-dibutyl-ethylenediamine; N,N′-di-tert-butyl-ethylenediamine, N,N′-diethyl-1,6-hexanediamine, 1-(1-methylethyl-amino)-3-(1-methylethyl-aminomethyl)-3,5,5-trimethylcyclohexane (Jefflink® 754 from Huntsman), N4-cyclohexyl-2-methyl-N2-(2-methylpropyl)-2,4-pentanediamine, N,N′-dialkyl-1,3-xylylenediamine, bis-(4-(N-alkylamino)-cyclohexyl)-methane, N-alkylated polyether amines, for example the Jeffamine® types SD-231, SD-401, SD-404 and SD-2001 from Huntsman, products from the Michael-type addition of primary aliphatic polyamines to Michael acceptors such as maleic acid diester, fumaric acid diester, citraconic acid diester, acrylic acid ester, methacrylic acid ester, cinnamic acid ester, itaconic acid diester, vinyl phosphonic acid diester, vinylsulfonic acid aryl ester, vinylsulfones, vinylnitrile, 1-nitroethylenes or Knoevenagel condensation products, such as, for example, those that consist of malonic acid diesters and aldehydes, such as formaldehyde, acetaldehyde or benzaldehyde;
Aliphatic polyamines with primary and secondary amino groups, such as, for example, N-cyclohexyl-1,3-propanediamine, N-butyl-1,6-hexanediamine, 4-aminomethyl-piperidine, 3-(4-aminobutyl)-piperidine, diethylenetriamine (DETA), dipropylenetriamine (DPTA), bis-hexamethylenetriamine (BHMT) and fatty diamines such as N-cocoalkyl-1,3-propanediamine, N-oleyl-1,3-propanediamine, N-(soya alkyl)-1,3-propanediamine, and N-talc alkyl-1,3-propanediamine and reaction products from the Michael-type addition reaction of aliphatic primary diamines with the already mentioned Michael acceptors in the molar ratio of 1:1;
Primary and/or secondary aromatic polyamines, such as, for example m- and p-phenylenediamine, 4′4-, 2,4′- and 2,2′-diaminodiphenylmethane, 3,3′-dichloro-4,4′-diaminodiphenylmethane (MOCA), 2,4- and 2,6-toluylenediamine, mixtures of 3,5-dimethylthio-2,4- and -2,6-toluylenediamine (available as Ethacure® 300 from Albemarle), mixtures of 3,5-diethyl-2,4- and -2,6-toluylenediamine (DETDA), 3,3′,5,5′-tetraethyl-4,4′-diaminodiphenylmethane (M-DEA), 3,3′,5,5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′,5,5′-tetraisopropyl-4,4′-diaminodiphenylmethane (M-DIPA), 4,4′-diaminodiphenylsulfone (DDS), 4-amino-N-(4-aminophenyl)-benzenesulfonamide, 5,5′-methylenedianthranilic acid, dimethyl-(5,5′-methylene dianthranilate), 1,3-propylene-bis-(4-aminobenzoate), 1,4-butylene-bis-(4-aminobenzoate), polytetramethylene oxide-bis-(4-aminobenzoate) (available as Versalink® from Air Products), 1,2-bis-(2-aminophenylthio)-ethane, N,N′-dialkyl-p-phenylenediamine, N,N′-dialkyl-4,4′-diaminodiphenylmethane, 2-methylpropyl-(4-chloro-3,5-diaminobenzoate), and tert-butyl-(4-chloro-3,5-diaminobenzoate).

As component parts of component K2, in addition the following are suitable: amino alcohols, in particular 2-(methylamino)ethanol, 2-(ethylamino)ethanol, 2-(butylamino)ethanol, 2-(cyclohexylamino)ethanol, 5-amino-1-pentanol, 6-amino-1-hexanol and higher homologs thereof, 4-(2-aminoethyl)-2-hydroxy-ethylbenzene, 3-aminomethyl-3,5,5-trimethyl-cyclohexanol, 2-(2-aminoethoxy)-ethanol, triethylene glycol monoamine, and higher oligomers and polymers thereof, 3-(2-hydroxyethoxy)-propylamine, 3-(2-(2-hydroxyethoxy)-ethoxy)-propylamine, 3-(6-hydroxyhexyloxy)-propylamine, diethanolamine, diisopropanolamine, 3-methyl-amino-1,2-propanediol, 2-(methylamino)ethanol, 2-(ethylamino)ethanol, 2-(butylamino)ethanol and 2-(cyclohexylamino)ethanol, 3-pyrrolidinol, 3- or 4-hydroxy-piperidine, 2-piperidine-ethanol, 2-[2-(1-piperazyl)]ethanol, 2-[2-(1-piperazyl)ethoxy]ethanol and N-hydroxyethylaniline.

As component parts of the component K2, in addition the following are suitable: blocked amines that can be activated hydrolytically with enamino, oxazolidino, aldimino and/or ketimino groups, in particular condensation products of the above-mentioned polyamines or amino alcohols with suitable aldehydes or ketones.

The component K2 can contain at least one polyol with a mean molecular weight of 250 to 30,000 g/mol, in particular from 400 to 20,000 g/mol, and a mean OH functionality in the range of 1.6 to 3.0.

The two-component composition can contain additional component parts, such as in adjuvants and additives that are usually used in polyurethane compositions, as already mentioned as component parts of a single-component composition, as well as a material that increases the heat conductivity of the composition and/or has piezoelectric, ferromagnetic or superparamagnetic properties, as also already mentioned as component parts of a single-component composition. Such additional component parts can be present as component parts of the first component K1 or as component parts of the second component K2.

As component parts of the component K2, still other adjuvants and additives are possible, in addition to those mentioned above, and namely those that can be stored only for a short time or not at all together with free isocyanate groups. For example, additional catalysts can be present, in particular compounds of zinc, manganese, iron, chromium, cobalt, copper, nickel, molybdenum, lead, cadmium, mercury, antimony, vanadium, titanium, zirconium or potassium, such as zinc(II) acetate, zinc(II)-2-ethylhexanoate, zinc(II)-laurate, zinc(II)-acetylacetonate, iron(III)-2-ethylhexanoate, cobalt(II)-2-ethylhexanoate, copper(II)-2-ethylhexanoate, nickel(II)-naphthenate, aluminum lactate, aluminum oleate, diisopropoxytitanium-bis-(ethylacetoacetate), potassium acetate; tertiary amines, such as N-ethyl-diisopropylamine, N,N,N′,N′-tetramethyl-alkylenediamines, pentamethyl-alkylenetriamines and higher homologs thereof, bis-(N,N-diethylaminoethyl)-adipate, tris-(3-dimethylaminopropyl)-amine, 1,4-diazabicyclo[2,2,2]octane (DABCO), 1,8-diazabicyclo[5,4,0]undec-7-ene (DBU), 1,5-diazabicyclo[4,3,0]non-5-ene (DBN), N-alkylmorpholines, N,N′-dimethylpiperazine, nitroaromatic compounds such as 4-dimethylamino-pyridine, N-methylimidazole, N-vinylimidazole, or 1,2-dimethylimidazole; organic ammonium compounds, such as benzyltrimethylammonium hydroxide or alkoxylated tertiary amines; so-called “delayed-action” catalysts, which represent alterations of known metal or amine catalysts; as well as combinations of the above-mentioned compounds, in particular metal compounds and tertiary amines.

When using such additional component parts, it can be advantageous to ensure that the latter do not unduly increase the solubility of the carboxylic acid hydrazide in the composition.

The production of the two components K1 and K2 can be carried out separately from one another and, at least for the component K1, under moisture-free conditions. The two components K1 and K2 have a long shelf life separately from one another (e.g., they can each be stored before their application for several months up to one year and longer in a suitable packaging or arrangement, such as, for example, a drum, a bag, a bucket, a cartridge or a bottle, without being altered in their respective properties to an extent relevant for their use).

Just shortly before or during the application of the two-component composition, the two components K1 and K2 can be mixed with one another, whereby for mixing, in particular a static mixer or a dynamic mixer is used, and the mixing can be carried out continuously or in batches.

The mixed two-component composition cures by hydroxyl, mercapto, amino and hydrolyzing blocked amino groups that are present in the composition reacting with existing isocyanate groups. Excess isocyanate groups react with moisture.

The curing composition can, for example, be present in the form of a single-component composition.

Exemplary curing compositions are disclosed that can, for example, comprise:

α) At least one polyisocyanate P, and

β) At least one carboxylic acid hydrazide,

provided that the ratio (n_{HY}−n_{AK})/n_{NCO} has a value of 0.2 to 3, in particular 0.5 to 2,

whereby n_{HY} stands for the number of hydrazide groups that are present in the composition,

n stands for the number of aldehyde and keto groups that are present and can be released into the composition; and

n_{CO} stands for the number of isocyanate groups that are present in the composition.

The carboxylic acid hydrazide and the polyisocyanate P can be present in the curing composition in the form of the previously described carboxylic acid hydrazides or the previously described polyisocyanates P and their exemplary embodiments.

The carboxylic acid hydrazide that is contained in the curing composition can have an exemplary melting point in the range of 160° C. to 260° C., in particular 175° C. to 240° C.

The carboxylic acid hydrazide that is contained in the curing composition can be a polycarboxylic acid hydrazide HY that is selected in particular from the group that consists of oxalic acid dihydrazide, adipic acid dihydrazide, azelaic acid dihydrazide, sebacic acid dihydrazide and isophthalic acid dihydrazide.

In accordance with exemplary embodiments, the carboxylic acid hydrazide in the curing of the curing composition does not act as a curing agent, but rather remains in free form during the curing in the cured composition or in the cured polyurethane adhesive.

In the curing of exemplary curing compositions at a low enough temperature, a cured polyurethane adhesive that contains the carboxylic acid hydrazide is produced. The maximum allowable temperature depends, for example, on the melting point of the existing carboxylic acid hydrazide.

A cured composition that contains at least one carboxylic acid hydrazide can be obtained, for example, by the curing of one of the described curing compositions at a temperature of below 80° C., in particular below 60° C.

Exemplary methods are disclosed for de-bonding an adhesive compound that comprise heating a cured polyurethane adhesive that contains a carboxylic acid hydrazide to an de-bonding temperature of at least 80° C.

In this method, the carboxylic acid hydrazide and/or the cured polyurethane adhesive are present in the form of the previously described carboxylic acid hydrazides or polyurethane adhesives and their exemplary embodiments.

The de-bonding temperature is, for example, above 100° C., in particular in the range of 120° C. to 240° C.

Most preferred is the de-bonding temperature in the range of 140° C. to 220° C.

An adhesive compound that comprises a cured polyurethane adhesive, which contains at least one carboxylic acid hydrazide, is available, for example, from a method for bonding a substrate S1 to a substrate S2, whereby this method comprises the steps:
i) Application of a curing composition, as it was previously described, to a substrate S1;
ii) Bonding of the applied composition to a substrate S2 within the open time of the composition;
or
i′) Application of a curing composition, as it was previously described, to a substrate S2;
ii′) Bonding of the applied composition to a substrate S1 within the open time of the composition;
or
i″) Application of a curing composition, as it was previously described, to a substrate S1 and a substrate S2;
ii″) Bonding of the applied composition together within the open time of the composition;

whereby substrate S2 consists of a material that is the same as or different from substrate S1;

and whereby these steps and the curing of the curing composition are carried out at temperatures of below 80° C., in particular below 60° C.

For the case that the curing composition is a two-component composition, the two components are mixed together before the application of the composition.

In this document, the time during which a single-component composition can be processed, after which the isocyanate groups of the polyisocyanate come into contact with moisture or during which a two-component composition can be processed, after which the two components are mixed together, is referred to as “open time.”

In this method, suitable substrates S1 and/or S2 are, for example:
Glass, glass ceramic, concrete, mortar, brick, adobe, cement and natural stone, such as granite or marble;
Metals or alloys, such as aluminum, steel, iron, nonferrous metals, galvanized metals;
Leather, textiles, paper, wood, resin-bonded wood products, resin-textile composite materials and other so-called polymer composites;
Plastics such as polyvinyl chloride (hard and soft PVC), acrylonitrile-butadiene-styrene copolymers (ABS), SMC (sheet molding compounds), polycarbonate (PC), polyamide (PA), polyester, poly(methylmethacrylate) (PMMA), polyester, epoxide resins, polyurethanes (PUR), polyoxymethylene (POM), polyolefins (PO), polyethylene (PE) or polypropylene (PP), ethylene/propylene copolymers (EPM), and ethylene/propylene/diene terpolymers (EPDM), whereby the plastics can be surface-treated preferably by plasma, corona or flame;
Coated substrates such as powder-coated metals or alloys; as well as paints and varnishes.

If desired, the substrates can be pretreated before the application of the curing composition. Such pretreatments can, for example, include physical and/or chemical cleaning processes, for example grinding, sandblasting, brushing, or the like, or treatment with cleaning agents or solvents or the application of an adhesion promoter, an adhesion-promoting solution or a primer.

Exemplary composites are disclosed that have a substrate S1, a substrate S2, and a cured polyurethane adhesive that is located between substrate S1 and substrate S2 and that contains at least one carboxylic acid hydrazide, which bonds substrate S1 and substrate S2 to one another.

In this composite, substrate S1 and substrate S2, or the carboxylic acid hydrazide or the cured polyurethane adhesive, are present in the form of the previously described substrates or carboxylic acid hydrazides, or polyurethane adhesives, and their exemplary embodiments.

Such a composite is available from the described methods for bonding a substrate S1 to a substrate S2.

An adhesive compound, as it was previously described, can be unstuck by the cured polyurethane adhesive that contains at least one carboxylic acid hydrazide being heated to a temperature of at least 80° C., in particular above 100° C. The heat that is used for this purpose can be produced with any energy source. Suitable means for heating are in particular convection ovens, hot-air blowers or infrared emitters. If at least one of the substrates is ferromagnetic and/or the composition contains a piezoelectric, ferromagnetic or superparamagnetic material, the heating can also take place by applying alternating magnetic and/or electrical fields, in particular microwaves or induction; this allows an especially quick heating of the cured polyurethane adhesive. By heating, the polyurethane polymer of the polyurethane adhesive is thermally degraded, whereby this thermal degradation is presumably primarily initiated by the carboxylic acid hydrazide that is present in the adhesive and its reactions with the polyurethane polymer. As a result, the adhesive is weakened relative to its strength, and the adhesive compound is ultimately unstuck in such a way that substrate S1 and substrate S2 can be separated from one another with relatively little effort.

A higher de-bonding temperature produces a faster thermal degradation of the polyurethane polymer and thus a faster de-bonding of the adhesive compound. A lower de-bonding temperature thus has to be maintained over a more extended period than a higher de-bonding temperature in order to de-bond an adhesive compound. De-bonding temperatures of above approximately 250° C. are, for example, used only very briefly or not at all, since in this case, toxic gases from the polyurethane polymer can be released, which involves special protective equipment and is therefore undesirable.

This disclosure for de-bonding an adhesive compound can be applicable for bonding to industrial goods, in particular for the assembly of household appliances, automobiles, transport vehicles, or ships. In addition, it can be applied for bonding in construction, for example for the adhesion of plates or panels to facades.

Adhesive compounds that can be unstuck thermally are, for example, especially advantageous for the repair of a composite. If a bonded component has to be replaced, it may be of great advantage if the adhesive compound can be unstuck thermally in a simple way, especially if the adhesive compound consists of a polyurethane adhesive with a very high strength. Thus, the adhesive does not have to be destroyed mechanically with much effort, but rather it need only be heated sufficiently so that, for example, a defective, glued component of an automobile can be replaced. The defective component can be removed with little effort after heating, and any adhesives residues can be removed from the body. These adhesive residues consist of thermally degraded polyurethane adhesive and therefore have marginal strength, but rather are paste-like to a large extent. As a result, they can be removed in a simple way, for example by means of a spatula, whereupon the body after a short cleaning with some solvent is ready for the bonding of a new component by means of a repair adhesive.

In addition, adhesive compounds that can be unstuck thermally can be advantageous for the case that the bonded components are to be used or recycled.

Exemplary repair methods are disclosed that comprise:
a) Heating a cured polyurethane adhesive of a composite,
   having a substrate S1, a substrate S2, and a cured polyurethane adhesive that is located between substrate S1 and substrate S2 and that contains at least one carboxylic acid hydrazide,
   to a temperature of at least 80° C., preferably above 100° C., in particular to a temperature in the range of 120° C. to 240° C., with de-bonding of the adhesive compound because of the heat-initiated thermal degradation of the cured polyurethane adhesive;
b) Subsequent removal of substrate S2 from the composite;
c) Subsequent removal of residues of the thermally degraded polyurethane adhesive that remain in any case on substrate S1;
d) Optionally subsequent cleaning and/or pretreatment of substrate S1;
   as well as either steps e) and f) or steps e′) and f′):
e) Application of a repair adhesive to substrate S1 subsequent to step c) or d); and
f) Bonding of the repair adhesive to a substrate S2′;
e′) Application of a repair adhesive to a substrate S2′ subsequent to step c) or d); and
f′) Bonding of the repair adhesive to substrate S1.

In this repair method, substrates S1, S2 and S2′ or the carboxylic acid hydrazide or the cured polyurethane adhesive are present in the form of the previously described substrates, or carboxylic acid hydrazides or polyurethane adhesives and their exemplary embodiments.

Substrate S2′ can be optionally pretreated before bonding with the repair adhesive, as previously described for a substrate S1 and S2.

As repair adhesive, in particular single-component or two-component polyurethane adhesives, for example curing compositions, as they were previously described, are suitable. Especially suitable repair adhesives are single- and two-component polyurethane adhesives, as they are commercially marketed by Sika Schweiz AG under the trade names Sikaflex® and Sikaforce®. It will be clear to those skilled in the art that a previously described curing composition that comprises at least one polyisocyanate and at least one carboxylic acid hydrazide can also be used as a repair adhesive. In this case, the described repair method can be performed again, if desired.

The use of a carboxylic acid hydrazide to de-bond—by heating—an adhesive compound that comprises a polyurethane adhesive can have various advantages. Carboxylic acid hydrazides can be crystalline substances with a slow solubility in polyurethane adhesive that are solid at room temperature. Thus, it is possible to use them as component parts of a curing polyurethane composition in the production of an adhesive compound, without them being incorporated into polyurethane polymer during the curing of the composition, provided that the curing takes place at a sufficiently low temperature. In addition, the cured polyurethane adhesive that contains a carboxylic acid hydrazide can have essentially the same properties as a correspondingly cured polyurethane adhesive without carboxylic acid hydrazide. For example, the adhesion proportion and partially also the mechanical properties, such as tensile strength, the modulus of elasticity (E-modulus) and elasticity, are barely changed by the presence of the free carboxylic acid hydrazide in the adhesive, provided that the use temperature of the adhesive compound is sufficiently low.

Another exemplary advantage when using a carboxylic acid hydrazide for de-bonding an adhesive compound is the fact that the de-bonding temperature that is used for de-bonding is not too high and/or that it has to be maintained only over a relatively short period in order to produce the de-bonding. As a result, the substrates of the adhesive compound to be unstuck are protected. Thus, in particular composites containing heat-sensitive materials, for example thermoplastic polymers such as polypropylene, can be unstuck.

Another exemplary advantage when using a carboxylic acid hydrazide for de-bonding an adhesive compound is the fact that carboxylic acid hydrazides can be less toxic substances whose presence in a polyurethane adhesive barely causes the adhesive to have a special characteristic.

Exemplary carboxylic acid hydrazides with a melting point in the range of 160° C. to 260° C., in particular 175° C. to 240° C., can have additional advantages. The curing of a corresponding curing composition can be carried out at somewhat higher temperatures, in particular up to about 80° C., without the carboxylic acid hydrazide being incorporated into the polyurethane polymer. In addition, they are suitable for somewhat higher use temperatures of the adhesive compound, for example up to temperatures in the range of about 60° C. to 100° C. For de-bonding such adhesive compounds, the de-bonding temperature can be advantageously above 100° C.

The especially preferred polycarboxylic acid hydrazides HY with a melting point in the range of 160° C. to 260° C., in particular 175° C. to 240° C., can have additional advantages. Because of their especially low solubility, they are unreactive to a large extent relative to free isocyanate groups at temperatures of up to about 60° C. As a result, they are especially suitable as component parts of single-component polyurethane compositions, which are to be stored over a certain period before their application.

Because of their especially low solubility in polyurethane adhesives, they are suitable for higher use temperatures of the adhesive compound, in particular for use temperatures in the range of about 80° C. to 100° C.

The fact that, on the one hand, carboxylic acid hydrazides can be used as component parts of curing polyurethane compositions that are suitable for storage and polyurethane adhesives cured therefrom that contain these carboxylic acid hydrazides are available in free, unincorporated form, and that, on the other hand, these cured adhesives can be used at use temperatures that are suitable for practical use, without in this case suffering a significant loss of strength, and that, in addition, the de-bonding of such adhesives is possible in a suitable temperature range within a relatively short time, is surprising and not obvious to one skilled in the art.

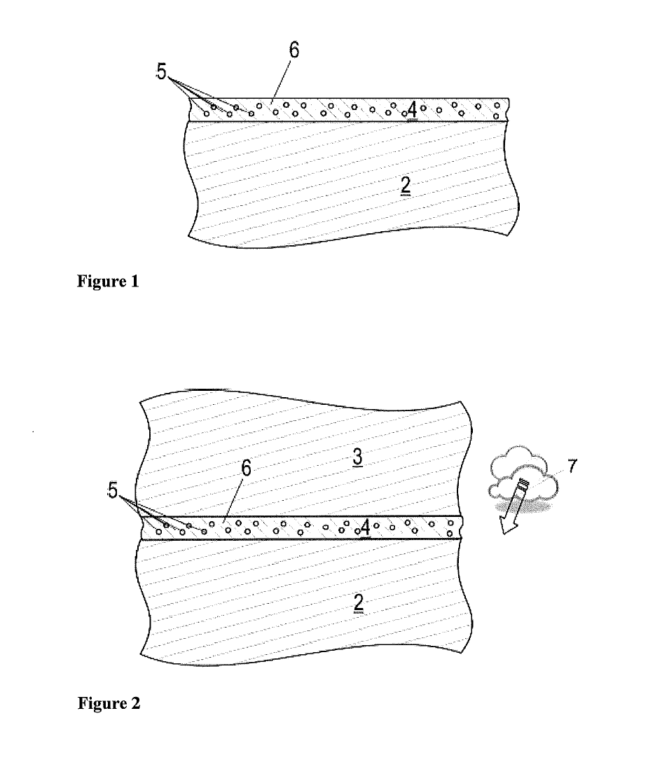

FIG. 1 shows an exemplary curing composition 4 that contains at least one carboxylic acid hydrazide 5 and at least one polyisocyanate 6, which has been applied to a substrate S1 2. Within the scope of this concrete example, substrate S1 2 represents a varnished metal flange. The size depiction of the carboxylic acid hydrazide particles is not to scale in this and subsequent depictions. The mean particle diameter of the carboxylic acid hydrazide is below 120 μm.

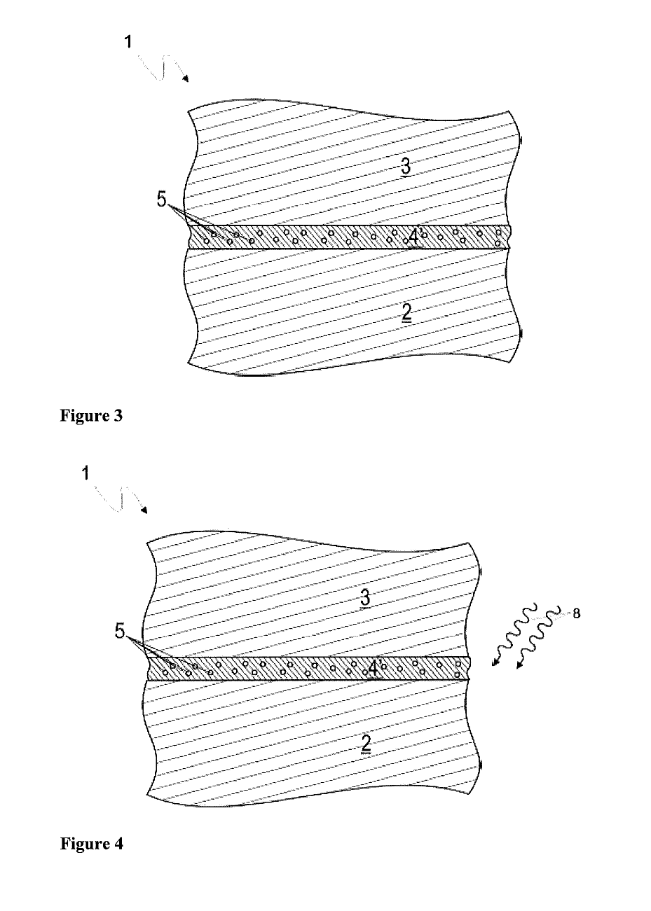

FIG. 2 shows the applied curing composition 4, which has been bonded to a substrate S2 3 within its open time. Within the scope of this concrete example, substrate S2 3 represents a windshield. In this concrete example, the curing composition 4 cures by means of atmospheric humidity 7 to form a cured polyurethane adhesive 4′ and thus forms a composite 1, as shown in FIG. 3, which has a substrate S1 2, a substrate S2 3, and a cured polyurethane adhesive 4′ that is located between substrate S1 2 and substrate S2 3 and that connects substrate S1 and substrate S2 to one another.

At a certain time, the adhesive compound is to be deliberately dissolved and therefore unstuck. This is the case, for example, when the windshield S2 3 has been damaged by stone-chipping and a new windshield is to be used.

At this time, which is shown in FIG. 4, the cured polyurethane adhesive 4′ of the composite 1 is heated by means of heat 8 to the de-bonding temperature of the adhesive.

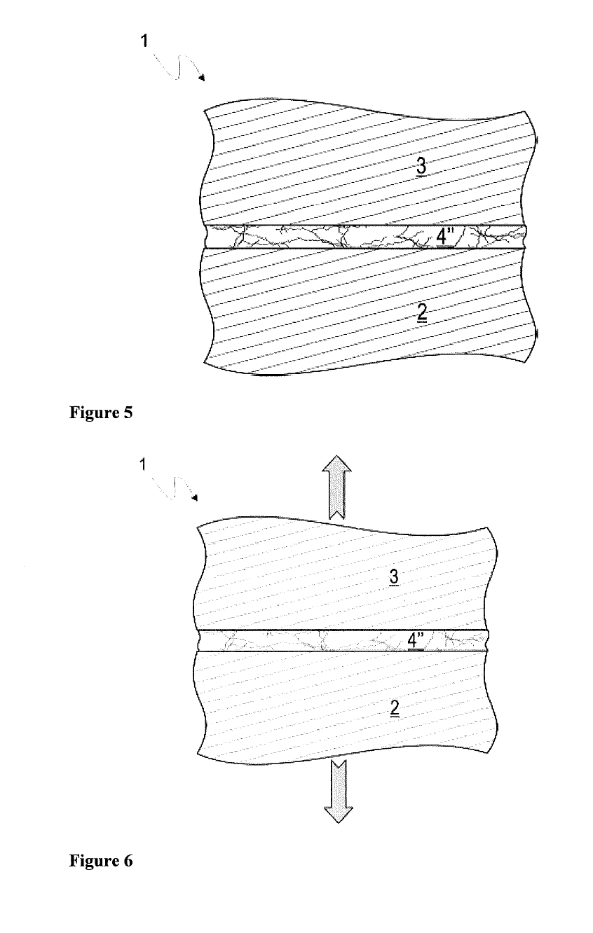

The carboxylic acid hydrazide 5 that is present in the cured polyurethane adhesive 4′ reacts because of the increased temperature and results in a thermally degraded polyurethane adhesive 4″, as depicted in FIG. 5.

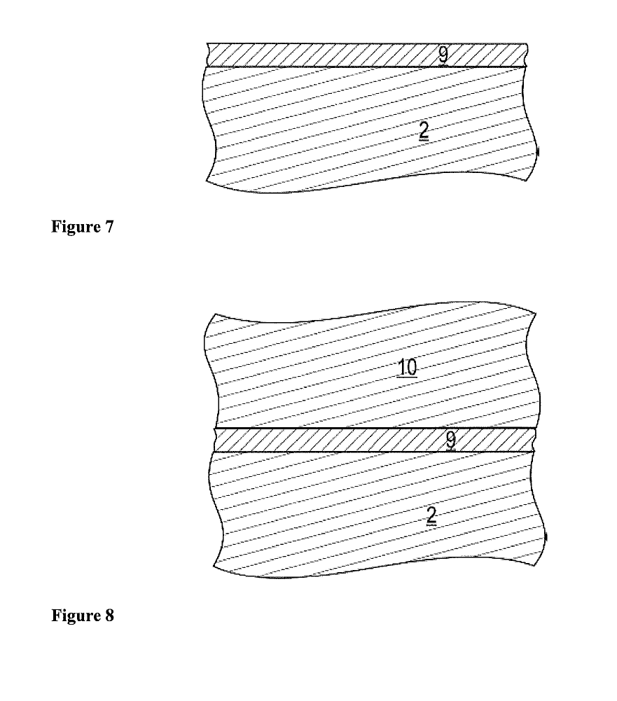

Then, substrate S2 3, here the damaged windshield, is removed by substrates S1 2 and S2 3 being mechanically separated or the adhesive compound being pulled out, as shown in FIG. 6. Residues of the thermally degraded polyurethane adhesive 4″ are removed, substrate S1 2 is cleaned, optionally pretreated, and ultimately, as depicted in FIG. 7, a repair adhesive 9 is applied to substrate S1 2. In FIG. 8, the repair adhesive 9 was bonded with a substrate S2′ 10, in this case a new windshield. After the repair adhesive 9 is cured, in turn a composite 1 is produced.

### Legend

1 Composite
2 Substrate S1
3 Substrate S2
4 Curing composition that contains at least one carboxylic acid hydrazide 5 and a polyisocyanate 6
4′ Cured polyurethane adhesive or cured composition
4″ Cured, thermally degraded polyurethane adhesive, or cured, thermally degraded composition
5 Carboxylic acid hydrazide
6 Polyisocyanate
7 Moisture
8 Heat
9 Repair adhesive
10 Substrate S2′

### Examples

A temperature of 23±1° C. and a relative atmospheric humidity of 50±5% are referred to as “standard atmosphere” (NK).

The ratio n_{HY}/n_{NCO} that is indicated in Tables 1 to 3 and 6 is in each case the ratio (n_{HY}−n_{AK})/n_{NCO}, whereby the value n_{AK} is equal to zero since the polyurethane adhesives that occur in the examples do not contain or release aldehydes and ketones. Here, in each case, it is thus the ratio of the number of hydrazide groups to the number of isocyanate groups.

1. Carboxylic Acid Hydrazides that are Used
Carboxylic acid hydrazide H-1 Adipic acid hydrazide Melting point about 180° C.
Carboxylic acid hydrazide H-2 Isophthalic acid dihydrazide Melting point about 220° C.
Carboxylic acid hydrazide H-3 Oxalic acid dihydrazide Melting point about 240° C.
Carboxylic acid hydrazide H-4 Isonicotinic acid hydrazide Melting point about 171° C.
Carboxylic acid hydrazide H-5 4-Nitrobenzhydrazide Melting point about 216° C.

The carboxylic acid hydrazides were used as fine-particle powder with a maximum particle size of <90 μm, determined by means of grindometer according to DIN EN 21 524.

2. Production of Polyurethane Adhesives

### Examples 1 to 3 and Comparison Example 4

In a polypropylene beaker with a screw closure, 60 parts by weight of Sikaflex® 221 White was mixed by means of a centrifugal mixer (Speed-Mixer™ DAC 150, FlackTek Inc.; 30 s at 3,000 rpm) with a carboxylic acid hydrazide according to Table 1 to form a homogeneous mass, said mass was decanted immediately into an aluminum cartridge that is varnished on the inside, and the cartridge is sealed in an airtight manner. The amounts are indicated in parts by weight.

Sikaflex® 221 White is a single-component polyurethane sealant and adhesive with a content of free isocyanate groups of about 0.7% by weight, available from Sika Schweiz AG.

The polyurethane adhesives were thereupon cured, and after varying storage times, they were tested at room temperature, at a drawing speed of 200 mm/min, for tensile strength, elongation at break and E-modulus at 0.5-5% expansion according to DIN EN 53504. To this end, an adhesive film with a thickness of 2 mm was produced by each example, and this film was cured for 7 days in standard atmosphere (NK). Twelve barbells with a length of 75 mm, a crosspiece length of 30 mm, and a crosspiece thickness of 4 mm were then punched out from the film, and three of them were immediately measured. The remaining 9 barbells were in each case stored in threes for 7 days in the convection oven at 80° C. or at 100° C. or at 120° C., and then measured. The results are indicated in Table 1, whereby the values in each case represent averages from three individual measurements.

TABLE 1
Composition and Results of Examples 1 to 3 and of
Comparison Example 4.

| | | Example | | | |
|---|---|---|---|---|---|
| | | | | | 4 |
| | | | | | (For |
| | | | | | Com- |
| | | 1 | 2 | 3 | parison) |
| Carboxylic Acid Hydrazide | | H-1, | H-2, | H-3, | — |
| | | 1.2 | 1.4 | 0.8 | |
| Sikaflex ® 221 White | | 60.0 | 60.0 | 60.0 | 60.0 |
| n_{HY}/n_{NCO} | | 1.4 | 1.4 | 1.4 | — |
| Tensile Strength [MPa] | (7 d NK) | 1.6 | 1.6 | 1.7 | 1.9 |
| Elongation at Break [%] | | 520 | 480 | 350 | 620 |
| E-Modulus [MPa] | | 3.3 | 2.8 | 3.6 | 2.6 |
| Tensile Strength [MPa] | (7 d NK + | 2.1 | 1.6 | 1.9 | 1.8 |
| Elongation at Break [%] | 7 d 80° C.) | 620 | 400 | 300 | 580 |
| E-Modulus [MPa] | | 3.2 | 2.3 | 4.1 | 3.0 |
| Tensile Strength [MPa] | (7 d NK + | 1.4 | 1.5 | 2.1 | 1.6 |
| Elongation at Break [%] | 7 d 100° C.) | 280 | 240 | 370 | 560 |
| E-Modulus [MPa] | | 2.8 | 2.5 | 3.6 | 2.8 |
| Tensile Strength [MPa] | (7 d NK + | 0.7 | 0.7 | 2.0 | 1.5 |
| Elongation at Break [%] | 7 d 120° C.) | 20 | 50 | 230 | 310 |
| E-Modulus [MPa] | | 5.4 | 2.6 | 3.7 | 2.7 |

From Table 1, it can be seen that the cured polyurethane adhesives of Examples 1 to 3 have good permanence up to temperatures of 100° C., comparable to that of Comparison Example 4 without carboxylic acid hydrazide. The polyurethane adhesive of Example 3 also still had good permanence at 120° C., while Examples 1 and 2 already showed a certain degradation of the polyurethane polymer.

### Example 5 to 8 and Comparison Example 9

Just as described for Example 1, additional polyurethane adhesives were produced according to the information in Table 2 (quantity information given in parts by weight). The composition of Example 7 corresponds to that of Example 1.

The polyurethane adhesives were thereupon cured and tested for Shore A hardness according to DIN 53505 after varying storage times. In addition, 4 specimens were produced from each adhesive, the latter were cured for 7 days under standard atmosphere (NK), and measured after that for Shore A hardness. Then, one specimen each was stored in a convection oven for 7 days at 80° C. or at 100° C. or at 120° C., and one specimen was stored in a convection oven for 10 minutes at 180° C., and then measured again for Shore A hardness. The results are indicated in Table 2.

TABLE 2
Composition and Results of Examples 5 to 8 and of Comparison
Example 9.

| | Example | | | | |
|---|---|---|---|---|---|
| | | | | | 9 |
| | | | | | (For |
| | 5 | 6 | 7 | 8 | Comparison) |
| Carboxylic Acid Hydrazide | H-1, | H-1, | H-1, | H-1, | — |
| | 0.4 | 0.8 | 1.2 | 1.6 | |
| Sikaflex ® 221 White | 60.0 | 60.0 | 60.0 | 60.0 | 60.0 |
| n_{HY}/n_{NCO} | 0.5 | 1.0 | 1.4 | 1.9 | — |
| Shore A | | | | | |
| (7 d NK) | 47 | 46 | 46 | 45 | 46 |
| (7 d NK + 7 d 80° C.) | 38 | 38 | 39 | 38 | 40 |
| (7 d NK + 7 d 100° C.) | 35 | 31 | 37 | 35 | 41 |
| (7 d NK + 7 d 120° C.) | 32 | 10 | <3 | <3 | 38 |
| (7 d NK + 10′ 180° C.) | 12 | 7 | <3 | <3 | 35 |

It can be seen from Table 2 that the cured polyurethane adhesives of Examples 5 to 8 have good permanence up to temperatures of 100° C. with varying amounts of adipic acid dihydrazide, comparable to that of Comparison Example 9 without carboxylic acid hydrazide. After 7 days at 120° C. and after 10 minutes at 180° C., Examples 6 to 8 showed a strong degradation of Shore A hardness, while Example 5, which had a substoichiometric amount of hydrazide groups relative to the existing isocyanate groups, was less strongly degraded.

### Examples 10 to 14

Just as described for Example 1, additional polyurethane adhesives were produced according to the information in Table 3 (quantity information given in parts by weight). The compositions of Examples 10, 11, and 12 correspond in each case to those of Examples 1, 2, and 3.

The polyurethane adhesives were thereupon cured, and after varying storage times, they were tested for Shore A hardness according to DIN 53505, as described for Example 5.

TABLE 3
Composition and Results of Examples 10 to 14.

| | Example | | | | |
|---|---|---|---|---|---|
| | 10 | 11 | 12 | 13 | 14 |
| Carboxylic Acid Hydrazide | H-1, | H-2, | H-3, | H-4, | H-5, |
| | 1.2 | 1.4 | 0.8 | 1.9 | 2.5 |
| Sikaflex ® 221 White | 60.0 | 60.0 | 60.0 | 60.0 | 60.0 |
| n_{HY}/n_{NCO} | 1.4 | 1.4 | 1.4 | 1.4 | 1.4 |
| Shore A | | | | | |
| (7 d NK) | 46 | 45 | 49 | 35 | 34 |
| (7 d NK + 7 d 80° C.) | 39 | 44 | 51 | 36 | 34 |
| (7 d NK + 7 d 100° C.) | 37 | 37 | 46 | 16 | 14 |
| (7 d NK + 7 d 120° C.) | <3 | 21 | 42 | n.d. | n.d. |
| (7 d NK + 10′ 180° C.) | <3 | 4 | 13 | <3 | <3 |

“n.d.” stands for “not determined”

It can be seen from Table 3 that the cured polyurethane adhesives of Examples 10 to 12, which contain dicarboxylic acid dihydrazides, have good permanence up to temperatures of 100° C. After 7 days at 120° C. and after 10 minutes at 180° C., Example 10 showed a strong reduction of Shore A hardness and thus a strong thermal degradation, while Examples 11 and 12 showed a reduction of Shore A hardness only under somewhat heavier thermal stress. Examples 13 and 14, which contain monocarboxylic acid hydrazides, already showed a degradation of Shore A hardness at a temperature stress of 7 days at 100° C.

3. Production of Composites

### Examples 15 to 17 and Comparison Example 18

With the polyurethane adhesives of Examples 1, 2 and 3 and Comparison Example 4, composites were produced based on the information in Table 4. In addition, in each case, 2 small glass plates with a 6 mm thickness, 25 mm width and 75 mm length (float glass; Rocholl Company, Schönbrunn, Germany) were pretreated with Sika® activator (available with Sika Schweiz AG). After a flash-off time of 10 minutes, the two small plates were bonded together so that they overlapped by 12 mm on the top ends, and the adhesive compound had a dimension of 12 mm×25 mm and a thickness of 4 mm. In this case, the activated sides of the small plates were in contact with the adhesive. For each example, 12 composites were produced.

The polyurethane adhesive in the composites was thereupon cured for 7 days under standard atmosphere (NK), and after varying storage times, the composites were tested for tensile shear strength, elongation at break, and E-modulus at 0.5-5% expansion using a tensile testing machine (Zwick) according to DIN EN 1465 at a constant transverse yoke speed of 20 mm/min. In addition, for each example, three of the 12 composites were measured directly after the curing. The remaining nine were stored for 7 days in the convection oven at 80° C., or at 100° C., or at 120° C., and then measured. The results are indicated in Table 4, whereby the values in each case represent mean values from three individual measurements.

TABLE 4
Results of Examples 15 to 17 and Comparison Example 18.

| | | Example | | | |
|---|---|---|---|---|---|
| | | | | | 18 |
| | | | | | (For |
| | | | | | Com- |
| | | 15 | 16 | 17 | parison) |
| Polyurethane Adhesive | | 1 | 2 | 3 | 4 |
| from Example | | | | | |
| Tensile Shear Strength [MPa] | (7 d NK) | 1.1 | 1.4 | 1.4 | 1.4 |
| Elongation at Break [%] | | 420 | 500 | 340 | 600 |
| E-Modulus [MPa] | | 0.6 | 0.8 | 0.8 | 0.6 |
| Tensile Shear Strength [MPa] | (7 d NK + | 1.3 | 1.4 | 1.6 | 1.5 |
| Elongation at Break [%] | 7 d | 350 | 400 | 330 | 520 |
| E-Modulus [MPa] | 80° C.) | 0.8 | 0.8 | 0.9 | 0.7 |
| Tensile Shear Strength [MPa] | (7 d NK + | 0.8 | 0.8 | 1.5 | 1.4 |
| Elongation at Break [%] | 7 d | 320 | 340 | 360 | 610 |
| E-Modulus [MPa] | 100° C.) | 0.5 | 0.5 | 0.7 | 0.5 |
| Tensile Shear Strength [MPa] | (7 d NK + | 0.1 | 0.2 | 0.9 | 1.2 |
| Elongation at Break [%] | 7 d | 50 | 90 | 300 | 390 |
| E-Modulus [MPa] | 120° C.) | 0.6 | 0.6 | 0.6 | 0.5 |

It can be seen from Table 4 that the adhesive compounds of the composites of Examples 15 to 17 have good permanence at temperatures of up to 100° C. The adhesive compound of Example 17 also still had good permanence at 120° C., while Examples 15 and 16 already showed a certain degradation of the polyurethane polymer.

4. De-Bonding of Adhesive Compounds

### Examples 19 to 21 and Comparison Example 22

Based on the information in Table 5, composites were produced with the polyurethane adhesives of Examples 1, 2 and 3 and Comparison Example 4, just as described in Example 15. These composites were cured for 7 days under standard atmosphere, and then the tests for de-bonding adhesive compounds were performed. In addition, in each case a set of three composites was heated in one convection oven each at 185° C. or 190° C. or 200° C. for 15 minutes. Then, the tensile shear strength of these composites was determined as described in Example 15.

TABLE 5
Results of Examples 19 to 21 and Comparison Example 22.

| | Example | | | |
|---|---|---|---|---|
| | | | | 22 |
| | | | | (For |
| | 19 | 20 | 21 | Comparison) |
| Polyurethane Adhesive from Example | 1 | 2 | 3 | 4 |
| Tensile Shear Strength [MPa] | 1.1 | 1.4 | 1.4 | 1.4 |
| (7 d NK) | | | | |
| Tensile Shear Strength [MPa] | n.m. | n.m. | 0.22 | 0.43 |
| (7 d NK + 15′ | | | | |
| 185° C.) | | | | |
| Tensile Shear Strength [MPa] | n.m. | n.m. | n.m. | 0.14 |
| (7 d NK + 15′ | | | | |
| 190° C.) | | | | |
| Tensile Shear Strength [MPa] | n.m. | n.m. | n.m. | 0.10 |
| (7 d NK + 15′ | | | | |
| 200° C.) | | | | |

“n.m.” stands for “not measurable” (adhesive too soft)

It can be seen from Table 5 that heating the composites of Examples 19 to 21 for 15 minutes in a convection oven that is heated to 185° C. or 190° C. or 200° C. produced a de-bonding of the adhesive compounds; the adhesives were either thermally degraded in such a way that the mechanical measurement of the tensile shear strength was no longer advisable, or its tensile shear strength dropped to a very low level. The mechanical separation of the small glass plates was thus possible with relatively little effort, and the adhesive compounds thus easily detachable. Under thermal stress, Comparison Example 22 without carboxylic acid hydrazide also showed a reduction of the tensile shear strength, but significantly less heavy than the examples according to the disclosure.

5. Tests on Shelf Life of Single-Component Compositions

### Examples 23 to 27 and Comparison Example 28

In a polypropylene beaker with a screw closure, 50 parts by weight of polymer P-1, whose production is described below, was mixed by means of a centrifugal mixer (Speed-Mixer™ DAC 150, FlackTek Inc.; 1 minute at 2,500 rpm) with a carboxylic acid hydrazide according to Table 6 to form a homogeneous mass, said mass was decanted immediately into an aluminum tube that is varnished on the inside, and the tube was sealed in an airtight manner. The amounts are indicated in parts by weight.

The polymer P-1 was produced as follows:

4,000 g of polyoxypropylene-diol (Acclaim® 4200 N, Bayer; OH number 28.5 mg of KOH/g) and 520 g of 4,4′-methylene diphenyl diisocyanate (MDI; Desmodur® 44 MC L, Bayer) were reacted at 80° C. to form an NCO-terminated polyurethane polymer with a content of free isocyanate groups of 1.90% by weight.

After varying storage times, the compositions were thereupon tested for their viscosity. In addition, for each example, the composition, after its production, was stored in the sealed tube in the oven at 60° C., and the viscosity was measured a first time after 1 day of storage time (=“viscosity 1 d 60° C.”) and a second time after 7 days of storage time (=“viscosity 7d 60° C”). In this case, viscosity was measured at 20° C. on a thermostated cone-plate-viscosimeter Physica UM (cone diameter 20 mm, cone angle 1°, cone tip-plate interval 0.05 mm, shear rate 10 to 1,000 s⁻¹). The results are presented in Table 6.

TABLE 6
Compositions and Results of Examples 23 to 27 and Comparison
Example 28.

| | Example | | | | | |
|---|---|---|---|---|---|---|
| | | | | | | 28 |
| | | | | | | (For |
| | 23 | 24 | 25 | 26 | 27 | Comparison) |
| Carboxylic Acid | H-1, | H-2, | H-3, | H-4, | H-5, | — |
| Hydrazide | 2.0 | 2.2 | 1.3 | 3.1 | 4.1 | |
| Polymer P-1 | 50.0 | 50.0 | 50.0 | 50.0 | 50.0 | 50.0 |
| n_{HY}/n_{NCO} | 1.0 | 1.0 | 1.0 | 1.0 | 1.0 | — |
| Viscosity [Pa · s] | 47 | 49 | 46 | 74 | Gelled | 45 |
| 1 d 60° C. | | | | | | |
| Viscosity [Pa · s] | 55 | 64 | 54 | Gelled | Gelled | 51 |
| 7 d 60° C. | | | | | | |

It can be seen from Table 6 that the compositions that contain the carboxylic acid hydrazides H-1, H-2 and H-3, which are dicarboxylic acid dihydrazides, showed only a slight increase in viscosity during storage and thus had a good shelf life at 60° C. The compositions that contain the carboxylic acid hydrazides H-4 and H-5, in which there are monocarboxylic acid hydrazides, gelled during storage, however. These carboxylic acid hydrazides obviously reacted with isocyanate groups despite their high melting point.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Method for de-bonding an adhesive compound, comprising:
heating a cured polyurethane adhesive that contains a carboxylic acid hydrazide; and
de-bonding the cured polyurethane adhesive using an de-bonding temperature of at least 80° C.

2. Method according to claim 1, wherein the carboxylic acid hydrazide has a melting point in a range of 160° C. to 260° C.

3. Method according to claim 1, wherein the carboxylic acid hydrazide has a melting point in a range of 175° to 240° C.

4. Method according to claim 1, wherein the carboxylic acid hydrazide is a polycarboxylic acid hydrazide HY, and is selected from a group that consists of oxalic acid dihydrazide, adipic acid dihydrazide, azelaic acid dihydrazide, sebacic acid dihydrazide and isophthalic acid dihydrazide.

5. Method according to claim 2, wherein the carboxylic acid hydrazide is a polycarboxylic acid hydrazide HY, and is selected from a group that consists of oxalic acid dihydrazide, adipic acid dihydrazide, azelaic acid dihydrazide, sebacic acid dihydrazide and isophthalic acid dihydrazide.

6. Method according to claim 3, wherein the carboxylic acid hydrazide is a polycarboxylic acid hydrazide HY, and is selected from a group that consists of oxalic acid dihydrazide, adipic acid dihydrazide, azelaic acid dihydrazide, sebacic acid dihydrazide and isophthalic acid dihydrazide.

7. Method according to claim 4, wherein the de-bonding temperature is above 100° C.

8. Method according to claim 4, wherein the de-bonding temperature is in a range of 120° C. to 240° C.

9. Method according to claim 4, wherein the de-bonding temperature is in a range of 140° C. to 220° C.

10. Curing composition, comprising:
α) at least one polyisocyanate P; and
β) at least one carboxylic acid hydrazide,
wherein a ratio (n_{HY}−n_{AK})/n_{NCO} has a value of 0.2 to 3,
whereby n_{HY} stands for a number of hydrazide groups that are present in the composition;
n_{AK} stands for a number of aldehyde and keto groups that are present and can be released into the composition; and
n_{NCO} stands for a number of isocyanate groups that are present in the composition.

11. Curing composition according to claim 10, wherein the ratio (n_{HY}—n_{AK})/n_{NCO} has a value of 0.5 t0 2.

12. Curing composition according to claim 10, wherein the carboxylic acid hydrazide has a melting point in a range of 160° C. to 260° C.

13. Curing composition according to claim 10, wherein the carboxylic acid hydrazide has a melting point in a range of 175° C. to 240° C.

14. Curing composition according to claim 10, wherein the carboxylic acid hydrazide is a polycarboxylic acid hydrazide HY and is selected from the group that consists of oxalic acid dihydrazide, adipic acid dihydrazide, azelaic acid dihydrazide, sebacic acid dihydrazide, and isophthalic acid dihydrazide.

15. Curing composition according to one of claim 10, wherein the composition is a single-component composition and wherein the polyisocyanate P is a polyurethane polymer PUP that has isocyanate groups.

16. Curing composition according to one of claim 10, wherein the composition is a two-component composition and consists of a first component K1 and a second component K2, whereby the first component K1 contains the polyisocyanate P and the second component K2 contains a polyol and/or a polythiol and/or a polyamine.

17. Cured composition that contains at least one carboxylic acid hydrazide, which is obtained by curing of a curing composition that contains:
α) at least one polyisocyanate P; and
β) at least one carboxylic acid hydrazide,
wherein a ratio (n_{HY}−n_{AK})/n_{NCO} has a value of 0.2 to 3,
whereby n_{HY} stands for a number of hydrazide groups that are present in the composition,
n_{AK} stands for a number of aldehyde and keto groups that are present and can be released into the composition; and
n_{NCO} stands for a number of isocyanate groups that are present in the composition. at a temperature of below 80° C.

18. Composite comprising:
a substrate S1;
a substrate S2; and
a cured composition that is located between substrate S1 and substrate S2 for bonding substrate S1 and substrate S2 to one another, the cured composition containing:
α) at least one polyisocyanate P; and
β) at least one carboxylic acid hydrazide,
wherein a ratio (n_{HY-n}_{AK})/n_{NCO} has a value of 0.2 to 3,
whereby n_{HY} stands for a number of hydrazide groups that are present in the composition;
n_{AK} stands for a number of aldehyde and keto groups that are present and can be released into the composition; and
n_{NCO} stands for a number of isocyanate groups that are present in the composition. at a temperature of below 80° C.

19. Method comprising:
a) heating a cured polyurethane adhesive of a composite, having a substrate S1, a substrate S2, and a cured polyurethane adhesive that is located between substrate S1 and substrate S2 and that contains at least one carboxylic acid hydrazide, to a temperature of at least 80° C., with de-bonding of an adhesive compound as a result of heat-initiated thermal degradation of the cured polyurethane adhesive;
b) removing the substrate S2 from the composite;
c) removing residues of the thermally degraded cured polyurethane adhesive that remain on the substrate S1;
d) applying a repair adhesive to at least one of substrate S1 or S2 subsequent to step c) or d); and
e) bonding of the repair adhesive to at least one of the substrate S1 or substrate S2′.

20. Method according to claim 19, wherein the heating is to a temperature in a range of 120° C. to 240° C.

21. Method according to claim 19, comprising:
cleaning and/or pretreating the substrate S1.
